(19) United States
(12) Patent Application Publication
(10) Pub. No.: US 2022/0197991 A1
(43) Pub. Date: Jun. 23, 2022

(54) PROVIDING A UNIQUE INITIAL PASSWORD

(71) Applicant: Hewlett-Packard Development Company, L.P., Spring, TX (US)

(72) Inventor: Kwangwoo LEE, Seongnam-si (KR)

(21) Appl. No.: 17/604,895

(22) PCT Filed: Apr. 24, 2020
(86) PCT No.: PCT/US2020/029835

§ 371 Date: Oct. 19, 2021

(30) Foreign Application Priority Data
Oct. 11, 2019 (KR) 10-2019-0126165

(51) Int. Cl. G06F 21/46; G06F 21/31

(52) U.S. Cl. CPC G06F 21/46; G06F 21/31

(57) ABSTRACT

An example method of controlling an electronic apparatus includes storing an initial password of the electronic apparatus, in response to receiving a request for the initial password, outputting the stored initial password, and after outputting the initial password, setting the electronic apparatus to prevent outputting the initial password in a recognizable form.

### BACKGROUND

An image forming apparatus refers to an apparatus for printing print data generated by a print control terminal such as a computer onto a recording medium such as paper. Examples of such an image forming apparatus include a copier, a printer, a scanner, a facsimile, or a multi-function printer that implements their functions in a single device.

### BRIEF DESCRIPTION OF THE DRAWINGS

Various examples will be described below by referring to the following figures.

FIG. 1 is a block diagram illustrating an electronic apparatus according to an example;

FIG. 2 is a block diagram illustrating an electronic apparatus according to an example;

FIG. 3 is a flowchart illustrating a control method of an electronic apparatus according to an example;

FIG. 4 is a view illustrating a device information page according to an example;

FIG. 5 is a view illustrating a user interface window according to an example; and

FIG. 6 is a flowchart illustrating an image forming method according to an example.

### DETAILED DESCRIPTION

Hereinafter, various examples will be described with reference to the accompanying drawings. The examples described below may be modified and implemented in various different forms. In order to more clearly describe features of the examples, detailed descriptions of matters well known to those skilled in the art to which the following examples belong will be omitted.

In the present disclosure, when an element is described as “connected” with another element, this includes not only “directly connected”, but also “connected with another element therebetween”. In addition, when one element is described to “include” another element, this means that, unless specifically stated otherwise, the one element may further include other elements rather than excluding other elements.

In the present disclosure, the term “image forming job” may refer to various tasks (e.g., printing, copying, scanning, or faxing) related to an image, such as forming an image or generating/storing/transmitting an image file, and the term “job” may refer not only to an image forming job but also a series of processes necessary for performing an image forming job.

In addition, the term “electronic apparatus” may refer to an apparatus in which an internal system setting, etc. is possible using a password. An “electronic apparatus” may refer to a personal computer (PC), a notebook computer, a tablet PC, a smartphone, an image forming apparatus, etc.

Further, the term “image forming apparatus” may refer to an apparatus for printing data generated in a terminal apparatus such as a computer onto a recording sheet. Examples of such an image forming apparatus include a copier, a printer, a scanner, a facsimile, or a multi-function printer (MFP) that implements their functions in a single device.

In addition, the term “print data” may refer to data converted into a format printable in a printer. Also, if a printer supports direct printing, a file itself may be print data.

Further, the term “user” may refer to a person who manipulates an electronic apparatus using a device connected with the electronic apparatus via cable or wirelessly. The term “administrator” may refer to a person who is authorized to have access to all functions and a system of an electronic apparatus. The terms “administrator” and “user” may refer to the same person.

In addition, the term “initial password” may refer to a password that may be used to access an electronic apparatus or an account (e.g., a user account or an administrator account) and may be a unique value and different for each electronic apparatus (e.g., different for each electronic apparatus shipped from a manufacturer). Such an initial password may be generated using information regarding at least one of a product serial number, a model name, a Media Access Control (MAC) address, a random number of an electronic apparatus, etc.

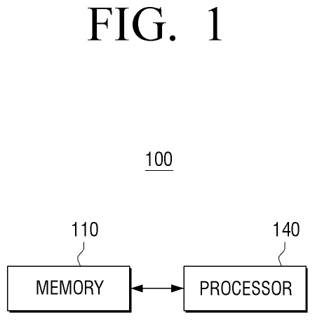

FIG. 1 is a block diagram illustrating an electronic apparatus according to an example.

Referring to FIG. 1, an electronic apparatus 100 may include a memory 110 and a processor 120.

The memory 110 may include at least one instruction for controlling the electronic apparatus 100. For example, the memory 110 may include various programs (or software) required to operate the electronic apparatus 100 according to various examples.

The electronic apparatus may provide various security functions such as network security, user authentication, a change of system setting, audit record, storage medium encryption, permanent deletion, access control, etc. Such security functions should be managed by a predetermined trusted user or administrator to ensure security.

To address a security concern, an initial password of an account required to perform security function management may be provided only to a user or an administrator who can directly access the electronic apparatus 100.

In this regard, the electronic apparatus 100 may store a unique initial password of the electronic apparatus 100. In various examples, the initial password may be originally stored at the time of initial shipment of the electronic apparatus 100, may be generated in an initial setting process of the electronic apparatus 100, or may be set at a time when the initial password is required (e.g., when a user requests an initial password).

For example, the initial password may be generated by combining a product serial number with a random number, by combining a MAC address with a random number, by combining a product serial number, a product name, a present date, a present time, and a random number, etc. Alternatively, the initial password may be generated through a function processing of unique values of the electronic apparatus 100 itself, for example, through a function processing and text processing for a product serial number. As such, a different initial password is given for each electronic apparatus 100 and security can be enhanced.

The processor 120 may control an operation of the electronic apparatus 100. For example, the processor 120 may control an operation of the electronic apparatus 100 by executing at least one instruction stored in the memory 110.

The processor 120 may determine whether the electronic apparatus 100 is booted initially and if so, may perform a series of operations for initial setting (or initial booting) of the options of the electronic apparatus 100.

Here, the initial setting may include an operation in which a default option value of the electronic apparatus 100 is set, a setting for wireless connection when the electronic apparatus 100 supports wireless communication, etc.

During such an initial setting process, the processor 120 may generate the initial password for accessing the electronic apparatus 100 or an account. For example, the processor 120 may generate the initial password by combining pre-stored unique information (e.g., a serial number, a MAC address, etc.) of the electronic apparatus 100, apparatus information (a model name, manufacturer information, etc.), data and time information, random information, etc.

The processor 120 may store the generated initial password in the memory 110. In an example, the initial password may not be generated by the electronic apparatus 100, but may be generated by a manufacturer and stored in the memory 110 in advance. In addition, the initial password may be generated at a time when a user requests the initial password, rather than at the time of initial booting.

If the manufacturer generates the initial password and stores it in the memory 110 in advance, the initial password may be stored in a cloud server and provided to an administrator.

When receiving a request for the initial password from a user, the processor 120 may determine whether it is possible to output the initial password. For example, the processor 120 may determine whether the user or the administrator changes the initial password required to access the electronic apparatus 100 or the account to another password, and if the initial password is not changed to another password, may determine that it is possible to output the initial password. If the user changes the password required to access the electronic apparatus 100 or the account, that is, if the current password is different from the initial password, the processor 120 may determine that it is not possible to output the initial password.

In the above examples, whether it is possible to output the initial password is determined by comparing the passwords directly. In other examples, plug information indicating a change of the password may be used. For example, if there is plug information indicating whether it is possible to output the initial password of the electronic apparatus 100, the processor 120 may determine whether it is possible to output the initial password based on a value of the plug information. If the account or the password of the electronic apparatus 100 has changed, the processor 120 may change the value of the above-described plug information.

If it is possible to output the initial password, the processor 120 may determine how to output the initial password. For example, if the electronic apparatus 100 is equipped with a print engine, the processor 120 may decide to output the initial password in a printing method. If the electronic apparatus 100 is equipped with a display, the processor 120 may decide to display the password using the display. In an example, the output method may be determined by the user selection, and if the user's request for initial password is based on the output command of a device information page, the processor 120 may decide to output the initial password in a printing method.

In addition, the processor 120 may output the initial password according to the determined method. For example, if it is determined that the initial password is provided in a printing method, the processor 120 may print the initial password. If the user's request for the initial password is based on the output of the device information page, the processor 120 may control a print engine 230 to print the device information page having the initial password along with the state information of the electronic apparatus 100.

If it is determined that it is not possible to output the initial password, a message indicating that the initial password cannot be output may be printed or displayed, or the device information page that does not display the initial password may be output.

Once the initial password is output, the processor 120 may request a change for the password. When the password is changed, the processor 120 may set the electronic apparatus 100 to prevent outputting the initial password in a recognizable form. For example, the processor 120 may update a value of the plug information related to the initial password to another value.

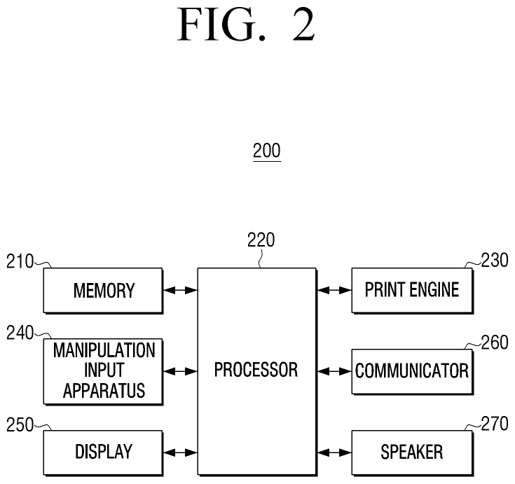

In the above described examples, only a brief configuration of the electronic apparatus 100 is illustrated and explained. However, in other examples, various elements may be further provided, which will be explained with reference to FIG. 2.

FIG. 2 is a block diagram illustrating an electronic apparatus according to an example.

Referring to FIG. 2, an electronic apparatus 200 may include a memory 210, a processor 220, a print engine 230, a manipulation input apparatus 240, a display 250, a communicator 260, and a speaker 270. In various examples, depending on the implementation of the electronic apparatus 200 of FIG. 2, for example if the electronic apparatus 200 is implemented as an image forming apparatus, some of the print engine 230, the display 250, the speaker 270, etc. may be omitted.

The memory 210 performs the same functions as the memory 110 of FIG. 1 and thus, a further description will not be provided. The processor 220 performs functions similar to the processor 120 of FIG. 1 and thus, an overlapping description will not be provided. Instead, only examples regarding the features added in FIG. 2 will be described below.

The print engine 230 may form an image. For example, the print engine 230 may print a print image generated by the processor 220 onto a printing medium such as paper. The print engine 230 may perform printing using an electro-photographic method, an ink-jet method, etc. In addition, the print engine 230 may be a mono print engine capable of printing only one color or may be a color print engine capable of color printing.

The print engine 230 may print an initial password. For example, the print engine 230 may output print data including the initial password only or a device information page including the initial password.

The manipulation input apparatus 240 may receive a function selection and a control command regarding a corresponding function from a user. Here, the function may include a print function, a copy function, a scan function, a fax transmission function, and the like.

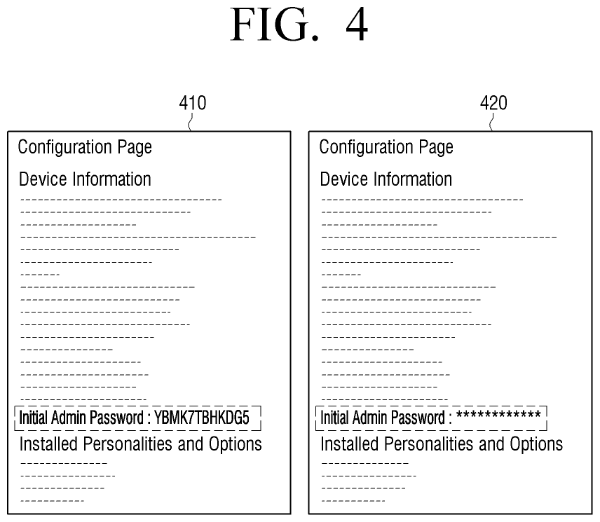

The manipulation input apparatus 240 may receive a command to display or print the initial password. For example, such a command may be a command requesting the initial password directly or a print command regarding a device information page including the initial password. Here, the device information page (e.g., a state page) is a page which is output in the process of testing whether the print function of an electronic apparatus is operating normally, and may include device information (e.g., a device name, device serial information, etc.) or various state information (e.g., toner amount information, etc.) of the electronic apparatus 100. An example of a device information page will be described later with reference to FIG. 4.

The manipulation input apparatus 240 may receive a selection of an initial password providing method from a user. For example, the user may select whether to display the initial password, whether to print the initial password on a printing medium, such as paper, or output the initial password through the speaker 270.

The manipulation input apparatus 240 may receive account information (e.g., an ID, a password, etc.) for accessing an electronic apparatus or the account, and may receive a new password regarding the electronic apparatus 200 or the account.

The display 250 may display a user interface window for receiving a function supported by the electronic apparatus 200. For example, the display 250 may display a user interface window for selecting various functions provided by the electronic apparatus 200. The display 250 may be a monitor such as a Liquid Crystal Display (LCD), a Cathode Ray Tube (CRT), a light emitting diode (LED), an Organic LED (OLED), etc., and may be implemented as a touch screen capable of performing the function of the manipulation input apparatus 240 simultaneously.

The display 250 may display a user interface window for receiving an initial setting. The user interface window may be displayed in the initial setup process of the electronic apparatus 200.

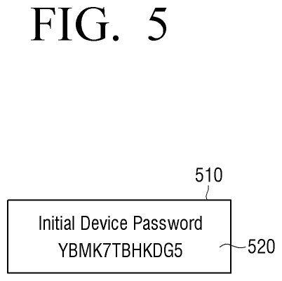

The display 250 may also display a user interface window for selecting whether to display or print the initial password and display the initial password. An example of the user interface window that can be displayed on the display 250 will be described later with reference to FIG. 5.

The display 250 may display a user interface window for receiving information for accessing the electronic apparatus 200 or an account. In an example, accessing the account for management of the electronic apparatus 200 may be performed by directly with the electronic apparatus 200 or through a remote user terminal apparatus via a network.

Once it is confirmed that the electronic apparatus 200 or the account is accessed using the initial password, the display 250 may request a change of the password of the electronic apparatus 200 or the account.

The communicator 260 is formed to connect the electronic apparatus 200 to an external device (not shown). In various examples, the electronic apparatus 200 may be connected to the external device not only through a Local Area Network (LAN) and an Internet network, but also through a Universal Serial Bus (USB) port or a wireless communication (e.g., WiFi 802.11a/b/g/n, Near Field Communication (NFC), Bluetooth, etc.) port. The communicator 260 may be referred to as a transceiver.

The communicator 260 may receive a control command through an external device and receive print data. In addition, the communicator 260 may receive log-in information for accessing the account of the electronic apparatus 200 and transmit/receive an authentication result in response to receiving the log-in information.

The communicator 260 may provide a web page. For example, the communicator 260 may provide a user terminal apparatus with a web page capable of setting various security functions such as network security, user authentication, a change of system setting, audit record, storage medium encryption, permanent deletion, access control, etc.

In addition, the communicator 260 may provide information regarding the electronic apparatus 200 to an external device. For example, if an NFC communication module is installed in the communicator 260, the apparatus information of the electronic apparatus 200 may be provided to a user by access of the user terminal apparatus. The above-described initial password may be included as one of such information. Accordingly, if the password of the electronic apparatus 200 or the account is the initial password, the initial password may be provided in the NFC communication method. Conversely, if the initial password is changed, the initial password is not provided even if an NFC tag is performed.

The speaker 270 may output state information of the electronic 200 apparatus through sound. For example, if the electronic apparatus 200 is in an error state, a sound corresponding to the error state may be output.

In addition, the speaker 270 may output the initial password of an electronic apparatus through a voice. For example, if the password of the electronic apparatus 200 or the account is the same as the initial password, the processor 220 may convert the initial password to a sound signal through Text to Speech (TTS), and output the converted sound signal using the speaker 270.

If the electronic apparatus 200 generates the initial password through an initial booting, the processor 220 may cause information regarding the generated password to be transmitted to a server (not shown).

If print data is received through the communicator 260, the processor 220 may control the print engine 230 to print the received print data.

If a request for displaying the initial password through the display 250 or outputting the initial password through the speaker 270 is received from a user, the processor 220 may determine whether it is possible to output the initial password. If possible, the processor 220 may control the display 250 to display the initial password, or control the speaker 270 to output a voice including the initial password.

In addition, if an NFC tag of an external device (not illustrated) is performed, the processor 220 may control the communicator 260 to transmit information regarding the electronic apparatus 200 to the corresponding external device through an NFC tag operation. If the initial password is the same as the password of the administrator account, the processor 220 may control the communicator 260 to transmit information regarding the initial password to the external device. If the password of the administrator is changed, the processor 220 may inactivate the operation of providing the initial password so that the initial password is not provided.

If the log-in of the electronic apparatus 200 or the account using the initial password is detected after the initial password is provided, the processor 220 may request a change of the password of the electronic apparatus 200 of the account to the administrator. For example, if the administrator accesses the account directly in the electronic apparatus 200, the above request may be displayed on the display 250. As another example, if the account access is performed through a network, the processor 220 may control the communicator 260 to transmit a user interface window for requesting a change of the password.

If the administrator forgets the changed password after changing the password, the administrator may perform factory initialization of the electronic apparatus 200. As such, if the electronic apparatus 200 is factory-initialized, the initial password may be restored as described above, and the initial password may be provided to the user or the administrator as described above.

As such, each electronic apparatus 200 according to an example has a unique initial password and thus, even if the initial password of one product is disclosed, it is possible to prevent access of an electronic apparatus 200 or an account of another product of the same model. In addition, the electronic apparatus 200 according to an example may secure the initial password only when the electronic apparatus 200 is directly and physically accessed and thus, the security of the initial password can be improved.

Further, the electronic apparatus 200 according to an example may provide the initial password to the user through the internal configuration of the electronic apparatus 200, thereby reducing the risk of losing information for providing the initial password in the delivery processor or the maintenance process of the electronic apparatus 200.

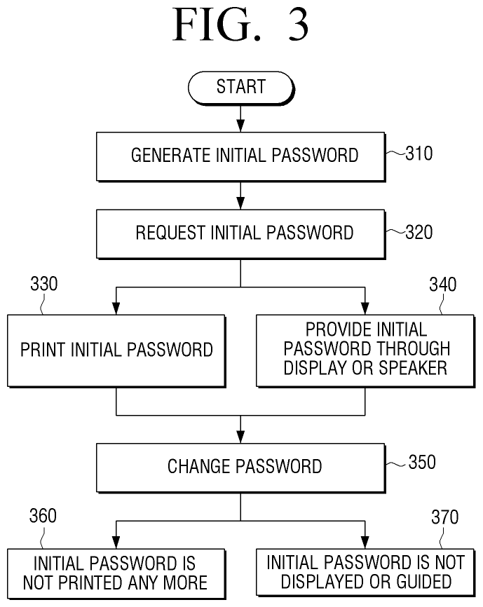

FIG. 3 is a flowchart provided to explain a controlling method of an electronic apparatus according to an example.

Referring to FIG. 3, an initial password may be generated and stored in operation 310. For example, the initial password may be generated by combining two or more pieces information such as unique key information of an image forming apparatus (e.g., serial information, MAC information, etc.), a model name, a random number, etc. Alternatively, the initial password may be generated through a function of processing unique key information. Such an initial password may be generated in the initial setting process of the electronic apparatus, or may be generated in advance by a manufacturer and stored in the electronic apparatus before the product is released.

In an example, when a manufacturer generates and provides the initial password, the manufacturer may provide the initial password together in a box in which the electronic apparatus is packaged, or by attaching the initial password to the surface of the electronic apparatus in the form of a sticker.

If a request for the initial password is received in operation 320, the initial password may be provided using a configuration page in operation 330 or through a display or a speaker in operation 340. For example, if the electronic apparatus does not have a display or a speaker, the initial password may be provided using a device information page, and if the electronic apparatus has a display or a speaker, the initial password may be provided through the display or the speaker. Such a request for the initial password may be a direct request for the initial password or a request for device information of the electronic apparatus.

Through the above process, a user may access the electronic apparatus or the account using the provided initial password and may change the password of the electronic apparatus or the account in operation 350.

When the password of the electronic apparatus or the account is changed, the electronic apparatus may be set to prevent outputting the initial password in a recognizable form. For example, if the password is changed, the plug related to the change of the password may be changed to a predetermined value.

Accordingly, when the initial password is provided through the display or the speaker, the initial password may be no longer printed in operation 360, or the initial password may not be output through the display or the speaker in operation 370. For example, if a request for a device information page is received after the password is changed, the information regarding the initial password may be deleted, or a device information page in which the password is replaced with a special character such as “*” may be printed.

As such, the controlling method of an electronic apparatus according to an example has a unique initial password and thus, even if the initial password of one product is disclosed, it is possible to prevent access of an administrator account of another product. In addition, according to an example controlling method of an electronic apparatus, the initial password may be secured only when the electronic apparatus is directly and physically accessed and the password generated by combining other information, rather than using the unique information of the electronic apparatus. Thus, the security of the initial password can be improved.

Further, an electronic apparatus according to an example may provide the initial password to the user through the internal configuration of the electronic apparatus, thereby reducing the risk of losing information for providing the initial password in the delivery processor or the maintenance process of the electronic apparatus.

The above-described example of a control method may be implemented as a program and provided in an electronic apparatus. In particular, the program including the electronic apparatus may be stored in a non-transitory computer readable medium and provided therein.

In illustrating and describing FIG. 3, it is explained that the electronic apparatus generates and uses the initial password. However, in other examples, a manufacturer may generate the initial password and store it in the electronic apparats in advance. In addition, it is explained that after the initial password is generated, the initial password is printed or displayed at the request of the user. However, in other examples, the password may be generated at the time when there is a user request. In other words, operation 310 and operation 320 of FIG. 3 may be implemented in the opposite manner.

FIG. 4 is a view illustrating a device information page according to an example.

Referring to FIG. 4, a first device information page 410 includes state information and an initial password of an electronic apparatus. The first device information page 410 may be output at the request of the user in the initial installation process of the electronic apparatus.

If the user accesses an account and changes the password of the account using the initial password included in the first device information page 410, the initial password may no longer be provided.

In other words, if the password of an account is changed from the initial password to another password, a second device information page 420 may include only the device information of the electronic apparatus and may not provide the initial password. In this case, as illustrated in the second device information page 420, the item of the initial password may be maintained, and the initial password may be displayed using a special character such as “*”, or a text indicating that the initial password cannot be provided may be displayed.

FIG. 5 is a view illustrating a user interface window according to an example.

Referring to FIG. 5, when a command requesting an initial password is input, a user interface window 510 may display the initial password 520.

If a user changes the password of an account after the initial password is provided, the user interface window 510 may replace the password with a special character such as “*” (e.g., as illustrated in second device information page 420 of FIG. 4), or may display that the initial password cannot be provided.

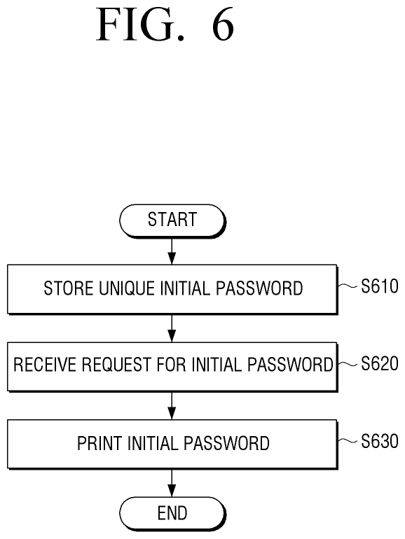

FIG. 6 is a flowchart provided to explain an image forming method according to an example.

Referring to FIG. 6, a unique initial password of an image forming apparatus may be stored in operation S610. Such an initial password may be generated by combining two or more pieces of information such as a serial number of the image forming apparatus, a model name, a MAC address, a random number, etc., or through a function of processing unique values of the electronic apparatus. The initial password may be generated and stored in advance by a manufacturer or may be generated and stored in the initial setting process of the electronic apparatus.

In addition, a request for the initial password regarding the electronic apparatus or the account may be received through a manipulation input apparatus in operation S620. Such a request for the initial password may be a state information request.

When the request is received, the unique initial password which is stored may be printed in operation S630. For example, whether it is possible to output the initial password may be determined by comparing the password of the current account with the initial password or by using a plug value indicating whether the initial password is maintained. If it is determined that the initial password can be output, the stored initial password may be printed.

After providing the initial password, if the user logs in to an administrator account using the initial password, the image forming apparatus may request a change of the initial password. Accordingly, when the password of the electronic apparatus or the account is changed, the function of providing the stored initial password may be inactivated. For example, if the initial password is provided by printing the device information page including the initial password in response to a user's request for the password, the initial password in the device information page may be replaced with another value such as “****” and displayed, or a phrase such as “the initial password has been changed” may be displayed.

As such, an image forming method according to an example allows each image forming apparatus to have a unique initial password. Thus, even if the initial password of one product is disclosed, it is possible to prevent access of an administrator account of another product. In addition, an image forming method according to an example makes it possible to secure the initial password only when the electronic apparatus is directly and physically accessed. Thus, the security of the initial password can be improved.

Further, an image forming method according to an example provides an initial password to a user through an internal configuration of an electronic apparatus, thereby reducing the risk of losing information for providing the initial password in the delivery process or the maintenance process of the image forming apparatus.

The above-described examples of image forming methods may be implemented as a program and provided in an image forming apparatus. For example, a program including an image forming method may be stored in a non-transitory computer readable medium and provided therein.

The non-transitory computer-readable medium refers to a medium that stores data semi-permanently, and is readable by machines, but not a medium that stores data for a short moment such as a register, a cache, and a memory. For example, the programs for performing the above-described various methods may be stored in a non-transitory computer-readable medium such as a Compact Disc (CD), a Digital Versatile Disc (DVD), a hard disc, a blue-ray disc, a USB, a memory card, a Read Only Memory (ROM) and the like and provided therein.

Although examples of the disclosure have been illustrated and described hereinabove, the disclosure is not limited to the examples as described above, and may be variously modified by those skilled in the art to which the disclosure pertains without departing from the gist of the disclosure as disclosed in the accompanying claims.

What is claimed is:

1. A control method of an electronic apparatus, the method comprising:
storing an initial password of the electronic apparatus;
in response to receiving a request for the initial password, outputting the stored initial password; and
after outputting the initial password, setting the electronic apparatus to prevent outputting the initial password in a recognizable form.

2. The method as claimed in claim 1, further comprising requesting a change of the initial password once the initial password is output.

3. The method as claimed in claim 2, wherein the setting of the electronic apparatus comprises, in response to the change of the initial password after the outputting of the initial password, setting the electronic apparatus to prevent outputting the initial password in a recognizable form.

4. The method as claimed in claim 1, wherein the outputting of the initial password comprises outputting the initial password in at least one of a print method, a display method, or an audio output method.

5. The method as claimed in claim 1, wherein the initial password is generated using information regarding at least one of a product serial number, a model name, a Media Access Control (MAC) address, or a random number of the electronic apparatus.

6. The method as claimed in claim 1, wherein the storing of the initial password comprises generating and storing the initial password during an initial setting process of the electronic apparatus.

7. The method as claimed in claim 1,
wherein the outputting of the initial password comprises printing a device information page including information regarding the electronic apparatus and the initial password, and
wherein the method further comprises, in response to a request for printing a device information page after the setting of the initial password, printing the device information page in which the initial password is not displayed.

8. An electronic apparatus comprising:
a memory to store at least one instruction and an initial password of the electronic apparatus; and
a processor to execute the at least one instruction,
wherein the processor is to:
in response to receiving a request for the initial password, output the stored initial password by executing the at least one instruction, and
after outputting the initial password, set the electronic apparatus to prevent outputting the initial password in a recognizable form.

9. The apparatus as claimed in claim 8, wherein the processor is further to request a change of the initial password once the initial password is output.

10. The apparatus as claimed in claim 9, wherein the processor is further to, in response to the change of the initial password after the outputting of the initial password, set the electronic apparatus to prevent outputting the initial password in a recognizable form.

11. The apparatus as claimed in claim 8, wherein the processor is further to output the initial password in at least one of a print method, a display method, or an audio output method.

12. The apparatus as claimed in claim 8, wherein the initial password is generated using information regarding at least one of a product serial number, a model name, a Media Access Control (MAC) address, or a random number of the electronic apparatus.

13. The apparatus as claimed in claim 8, wherein the processor is further to generate and store the initial password during an initial setting process of the electronic apparatus.

14. The apparatus as claimed in claim 8, wherein the processor is further to:
print a device information page including information regarding the electronic apparatus and the initial password, and
in response to a request for printing the device information page after the setting of the initial password, print a device information page in which the initial password is not displayed.

15. An image forming method comprising:
storing an initial password of an image forming apparatus;
receiving a request for the initial password through a manipulation input apparatus of the image forming apparatus; and
in response to receiving the request, printing the initial password.
